(19) United States
(12) Patent Application Publication
(10) Pub. No.: US 2022/0185101 A1
(43) Pub. Date: Jun. 16, 2022

(54) PURGE SYSTEM OF FUEL VAPOR AND METHOD THEREOF

(71) Applicants: HYUNDAI MOTOR COMPANY, Seoul (KR); KIA CORPORATION, Seoul (KR)

(72) Inventor: Byungchul Ko, Incheon (KR)

(21) Appl. No.: 17/317,307

(22) Filed: May 11, 2021

(30) Foreign Application Priority Data
Dec. 11, 2020 (KR) 10-2020-0173135

(51) Int. Cl. B60K 15/035

(52) U.S. Cl. CPC B60K 15/03504; B60K 15/03519; B60K 2015/0323; B60K 2015/03595; B60K 2015/03576

(57) ABSTRACT

A purge system of a fuel vapor includes a sensor sensing an operation of a refueling button, a fuel tank isolation valve provided on a vapor line connecting a fuel tank and a canister, an active purge pump provided on a purge line connecting the canister and an intake system, and a controller opening the fuel tank isolation valve and operating the active purge pump if the operation of the refueling button is recognized by the sensor to trap the fuel vapor generated from the fuel tank into the purge line.

### CROSS REFERENCE TO RELATED APPLICATIONS

This application claims priority to and the benefit of Korean Patent Application No. 10-2020-0173135 filed in the Korean Intellectual Property Office on Dec. 11, 2020, the entire contents of which are incorporated herein by reference.

### BACKGROUND

### (a) Field

The present disclosure relates to a purge system of a fuel vapor and a method thereof. More particularly, the present disclosure relates to a purge system of a fuel vapor and a method thereof capable of trapping a fuel vapor generated during refueling by using an active purge pump.

### (b) Description of the Related Art

In order to enhance an exhaust gas, research has been performed in the vehicle industry, and particularly, in order to minimize discharge of hydrocarbons (HC) among evaporation gas components of gasoline fuel, countries have adapted regulations that regulate a total amount of fuel evaporation gas to 0.5 g/day or less, and are scheduled to sequentially reduce a total amount of fuel evaporation gas to 0.054 g/day or less.

Generally, in order to cope with such regulations, by improving a material of a fuel tank and optimizing a connection structure thereof, occurrence of a fuel evaporation gas that penetrates the fuel tank has been minimized, and a fuel vapor recirculation apparatus in which a canister is applied to a fuel supply apparatus has been used.

Here, the canister contains an adsorbent material that can absorb a fuel evaporation gas from a fuel tank that stores a volatile fuel, and in order to prevent a fuel vapor that evaporates from a float chamber of a vaporizer and the fuel tank from being discharged to the air, the canister is connected with the fuel tank to collect the fuel vapor.

In this way, the fuel evaporation gas that is collected in the canister is again injected into the engine through a Purge Control Solenoid Valve (PCSV) that is controlled by an Engine Control Unit (ECU) to be burned, and thus the fuel vapor is recirculated.

On the other hand, since the engine is turned off during the refueling, the fuel vapor generated from the fuel tank during the refueling is collected in the canister, and when the amount of fuel vapor generated from the fuel tank exceeds the capacity of the canister, it is exhausted into the atmosphere.

In this way, in order to minimize the amount of the fuel vapor exhausted into the atmosphere during the refueling, the capacity of the canister was conventionally increased.

However, when the capacity of the canister is increased to collect the fuel vapor, the volume of the canister increases, and there is a problem that the manufacturing cost for manufacturing a high-capacity canister increases.

The above information disclosed in this background section is only for enhancement of understanding of the background of the disclosure, and therefore it may contain information that does not form the prior art that is already known in this country to a person of ordinary skill in the art.

### SUMMARY

An object of the present disclosure is to provide a purge system of a fuel vapor and a method capable of preventing the fuel vapor generated during the refueling from being exhausted to the outside.

In addition, it is another object to provide a purge system of a fuel vapor and a method thereof that can reduce the volume of the canister by reducing the capacity of the canister for collecting fuel vapor and reduce the manufacturing cost for manufacturing the canister.

A purge system of a fuel vapor according to an exemplary embodiment of the present disclosure may include a sensor sensing an operation of a refueling button, a fuel tank isolation valve provided on a vapor line connecting a fuel tank and a canister, an active purge pump provided on a purge line connecting the canister and an intake system, and a controller opening the fuel tank isolation valve and operating the active purge pump if the operation of the refueling button is recognized by the sensor to trap the fuel vapor generated from the fuel tank into the purge line.

The controller may open the fuel tank isolation valve for a predetermined time and operate the active purge pump after the operation of the refueling button is recognized by the sensor.

After the predetermined time elapses, the controller may block the fuel tank isolation valve and stop the operation of the active purge pump.

A fuel vapor purge method according to another exemplary embodiment of the present disclosure may include sensing an operation of a refueling button by a sensor, and controlling a fuel tank isolation valve provided on a vapor line connecting a fuel tank and a canister and an operation of an active purge pump provided on a purge line connecting a canister and an intake system by a controller based on an operation of the refueling button.

If the operation of the refueling button is recognized, the fuel tank isolation valve is opened and the active purge pump may be operated during a predetermined time.

If the predetermined time has elapsed, the fuel tank isolation valve may be shut off and the operation of the active purge pump stops.

In the purge system of the fuel vapor according to an exemplary embodiment of the present disclosure, by trapping the fuel vapor generated in the fuel tank during the refueling into the purge line using the active purge pump, it is possible to prevent the fuel vapor from exhausting into the atmosphere.

Also, since it is not necessary to increase the capacity of the canister to collect the fuel vapor generated during the refueling, the volume of the canister may be reduced and the manufacturing cost of the canister may be reduced.

### BRIEF DESCRIPTION OF THE FIGURES

The drawings are provided for reference to explain an illustrative exemplary embodiment of the present disclosure, and the technical spirit of the present disclosure should not be interpreted to be limited to the accompanying drawings.

FIG. 1 is a schematic view showing a configuration of a purge system of a fuel vapor according to an exemplary embodiment of the present disclosure.

FIG. 2 is a block diagram showing a configuration of a purge system of a fuel vapor according to an exemplary embodiment of the present disclosure.

FIG. 3 is a flowchart showing a purge method of a fuel vapor according to an exemplary embodiment of the present disclosure.

FIG. 4 is a view to explain an operation of a purge system of a fuel vapor according to an exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In addition, parts not related to the description are omitted for clear description of the present disclosure, and like reference numerals designate like elements and similar constituent elements throughout the specification.

In addition, the size and thickness of each component shown in the drawings are arbitrarily shown for ease of understanding and description, but the present disclosure is not limited thereto.

Hereinafter, a purge system of a fuel vapor according to an exemplary embodiment of the present disclosure is described with reference to accompanying drawings.

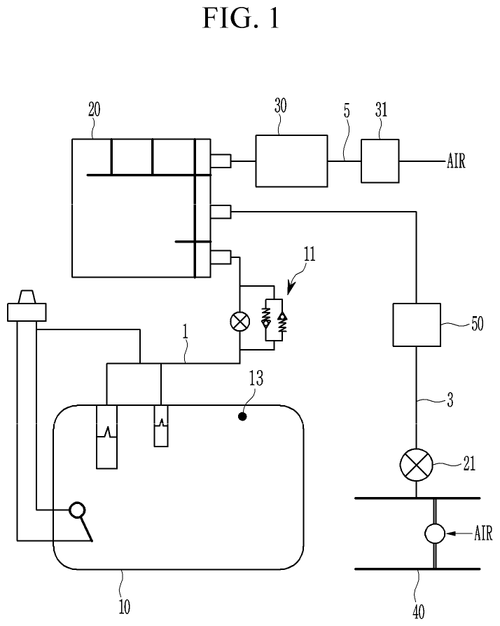

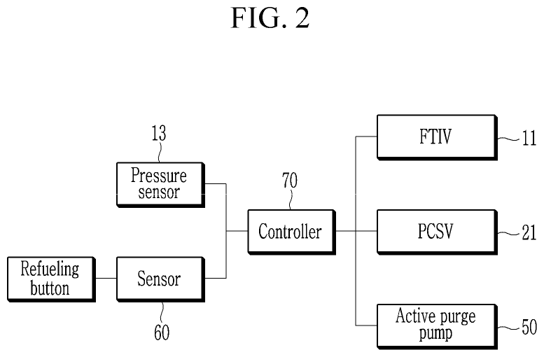

FIG. 1 is a schematic view showing a configuration of a purge system of a fuel vapor according to an exemplary embodiment of the present disclosure. FIG. 2 is a block diagram showing a configuration of a purge system of a fuel vapor according to an exemplary embodiment of the present disclosure.

As shown in FIG. 1 and FIG. 2, a purge system of a fuel vapor according to an exemplary embodiment of the present disclosure may include a fuel tank 10, a canister 20, an intake system 40 and a controller 70.

The intake system 40 may include an engine, an intake manifold, and an intake line where intake air inflowing to the engine and the intake manifold flows.

The engine includes a plurality of cylinders generating a driving torque by the combustion of the fuel. The engine is equipped with an intake line through which the intake air supplied to the cylinder flows and an exhaust line through which the exhaust gas exhausted from the cylinder flows.

The air (or the outside air) flowing through the intake line is supplied to the cylinder through the intake manifold. At the front end (or an upstream) of the intake manifold, a throttle valve that controls the amount of the air supplied to the cylinder of the engine is mounted.

A volatile fuel supplied to the engine cylinder is stored in the fuel tank 10. The fuel tank 10 is equipped with a pressure sensor 13, and the pressure sensor 13 senses the internal pressure of the fuel tank 10 and transmits it to the controller 70.

The fuel tank 10 and the canister 20 are connected (or communicated) through a vapor line 1, and a fuel tank isolation valve 11 (FTIV) is installed in the vapor line 1. The canister 20 and the fuel tank 10 are selectively opened or closed according to the on/off of the fuel tank isolation valve 11.

When refueling the fuel tank 10, in the case that the pressure of the fuel tank 10 is higher than a predetermined pressure, the fuel tank isolation valve 11 is opened such that the vapor line 1 between the fuel tank 10 and the canister 20 is opened. Thus, the fuel vapor moves from the fuel tank 10 to the canister 20.

The canister 20 includes an adsorbent material capable of trapping the fuel vapor generated from the fuel tank 10.

The canister 20 and the intake system 40 (e.g., an intake manifold) are connected (or communicated) through a purge line 3, and a purge control solenoid valve (PCSV) 21 is mounted on the purge line 3. By the operation of a purge control solenoid valve 21, the supply of the fuel vapor collected from the canister 20 to the intake system 40 is selectively opened or blocked.

An active purge pump 50 is installed in the purge line 3 between the canister 20 and the purge control solenoid valve 21. When the fuel vapor generated from the fuel tank 10 is purged to the intake system 40 of the engine (e.g., when the internal pressure of the fuel tank is higher than a predetermined pressure), the active purge pump 50 operates in the state that the purge control solenoid valve 21 is opened so that the fuel vapor collected from the canister 20 is supplied to the intake system 40 through the purge line 3.

In the case of a natural intake engine, the fuel vapor generated in the fuel tank 10 and collected in the canister 20 is supplied to the intake system 40 by using a negative pressure of the intake system 40. However, in the case of hybrid vehicles, the fuel vapor purge method in this natural intake engine may not be used. In addition, when a turbocharger including a turbine and a compressor, or an electric supercharger including a compressor operated by an electric motor, is mounted on the vehicle to increase the output of the engine, since a case that the pressure of the intake system 40 is higher than the atmospheric pressure occurs, the fuel vapor purge method in the natural intake engine may not be used.

Therefore, in the case of the hybrid vehicle or the vehicle mounted with a turbocharger or a supercharger such as an electric supercharger, the fuel vapor is compressed through the active purge pump 50 mounted on the purge line 3 and supplied to the intake system 40.

The canister 20 is equipped with a vent line 5 to communicate with the atmosphere, and an evaporative leak check module (ELCM) 30 is mounted on the vent line 5 to diagnose fuel vapor leaks. The ELCM 30 is for diagnosing the leaks of the fuel vapor at a soaking time (e.g., when parking, etc.) when the vehicle is not driving.

A filter 31 is provided in the vent line 5 downstream of the ELCM 30, and some of the fuel vapor collected in the canister 20 may be exhausted to the atmosphere through the filter 31.

On the other hand, the purge system of the fuel vapor according to an exemplary embodiment of the present disclosure may include a sensor 60 sensing the operation of the refueling button and a controller 70 controlling the operations of the fuel tank isolation valve 11, the purge control solenoid valve 21, and the active purge pump 50 based on the operation of the refueling button sensed from the sensor 60.

The sensor 60 detects the operation of the refueling button by the user's manipulation, and the operation of the refueling button detected by the sensor 60 is transmitted to the controller 70.

The controller 70 may be provided with at least one processor operating by a predetermined program, and the predetermined program is configured to perform each step of the fuel vapor purge method according to an exemplary embodiment of the present disclosure.

Hereinafter, the operation of the purge system of the fuel vapor according to an exemplary embodiment of the present disclosure is described in detail with reference to accompanying drawings.

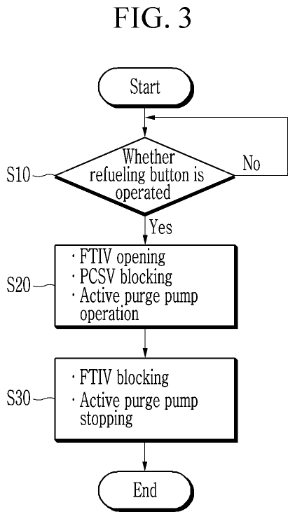

FIG. 3 is a flowchart showing a purge method of a fuel vapor according to an exemplary embodiment of the present disclosure.

As shown in FIG. 3, the sensor 60 detects the operation of the refueling button by the user's manipulation, and the operation of the refueling button detected by the sensor 60 is transmitted to the controller 70 at S10.

When the sensor detects that the refueling button has been operated, it may be determined that the refueling has started into the fuel tank 10, and the controller 70 opens the fuel tank isolation valve 11 for a predetermined time (e.g., 200 seconds). Also, the controller 70 operates the active purge pump 50 for a predetermined time (e.g., 200 seconds). At this time, the controller 70 blocks the purge control solenoid valve at S20.

In this way, as the fuel tank isolation valve 11 is opened and the purge control solenoid valve is blocked, the fuel tank 10-the vapor line 1-the canister 20-the purge line 3-the purge control solenoid valve form a closed loop.

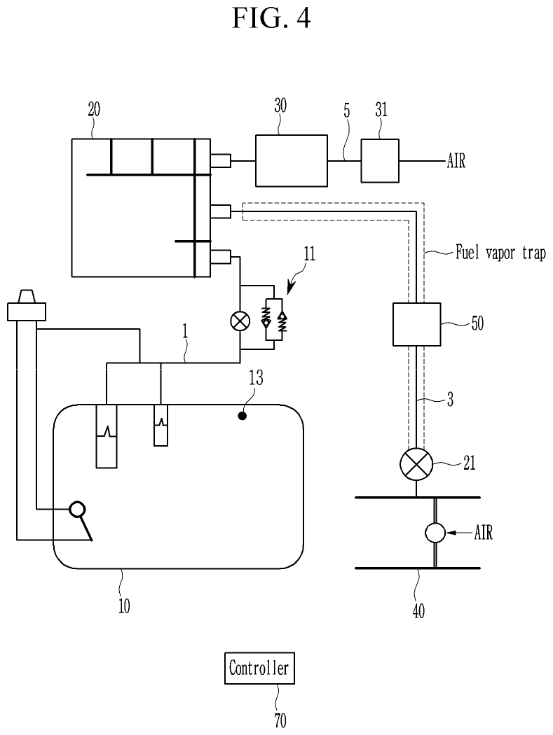

As the fuel tank isolation valve 11 is opened and the active purge pump 50 is operated, the fuel vapor generated from the fuel tank 10 during the refueling is collected in the canister 20 through the vapor line 1, and the fuel vapor collected in the canister 20 moves to the purge line 3. The active purge pump 50 installed in the purge line 30 compresses the fuel vapor, and the fuel vapor compressed by the active purge pump 50 is trapped in the purge line 3 (referring to FIG. 4). Therefore, the fuel vapor collected in the canister 20 is not exhausted into the atmosphere through the vent line 50.

When the predetermined time elapses, the controller 70 blocks the fuel tank isolation valve 11 and stops the operation of the active purge pump 50 at S30.

By operating the active purge pump 50 only for a predetermined period of time, unnecessary power consumption is minimized while the engine is stopped.

As described above, according to the purge system of the fuel vapor and the method thereof according to an exemplary embodiment of the present disclosure, by trapping the fuel vapor generated in the fuel tank during the refueling to the purge line by the operation of the active purge pump 50, it is possible to suppress the fuel vapor from being exhausted into the atmosphere.

In addition, as the capacity of the canister for collecting the fuel vapor generated from the fuel tank may be minimized, so the volume of the canister may be reduced and the cost of manufacturing the canister may be reduced.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

1. A purge system of a fuel vapor comprising:
a sensor configured to sense an operation of a refueling button;
a fuel tank isolation valve provided on a vapor line connecting a fuel tank and a canister;
an active purge pump provided on a purge line connecting the canister and an intake system; and
a controller configured to open the fuel tank isolation valve and to operate the active purge pump if the operation of the refueling button is recognized by the sensor to trap the fuel vapor generated from the fuel tank into the purge line.

2. The purge system of the fuel vapor of claim 1, wherein the controller opens the fuel tank isolation valve for a predetermined time and operates the active purge pump after the operation of the refueling button is recognized by the sensor.

3. The purge system of the fuel vapor of claim 2, wherein after the predetermined time elapses, the controller blocks the fuel tank isolation valve and stops the operation of the active purge pump.

4. A fuel vapor purge method comprising:
sensing an operation of a refueling button by a sensor; and
controlling, by a controller, a fuel tank isolation valve provided on a vapor line connecting a fuel tank and a canister, and controlling an operation of an active purge pump provided on a purge line connecting a canister and an intake system based on the operation of the refueling button.

5. The fuel vapor purge method of claim 4, wherein if the operation of the refueling button is recognized, the fuel tank isolation valve is opened and the active purge pump is operated during a predetermined time.

6. The fuel vapor purge method of claim 5, wherein if the predetermined time has elapsed, the fuel tank isolation valve is shut off and the operation of the active purge pump stops.
